(19) United States
(12) Patent Application Publication
(10) Pub. No.: US 2026/0304238 A1
(43) Pub. Date: Oct. 1, 2026

(54) RESTRICTING FEMTOCELL ACCESS BASED ON DEVICE VONR CAPABILITY AND TRACKING AREA IDENTIFICATION

(71) Applicant: T-MOBILE INNOVATIONS LLC, Overland Park, KS (US)

(72) Inventors: Kunal Prakash Barawkar, Bothell, WA (US); Hang Hoi Yau, Sammamish, WA (US); Jun Wang, Sammamish, WA (US)

(21) Appl. No.: 19/097,323

(22) Filed: Apr. 1, 2025

(51) Int. Cl. H04W 36/00

(52) U.S. Cl. CPC H04W 36/00222; H04W 36/0061; H04W 36/0079

(57) ABSTRACT

Systems and methods are disclosed for dynamically restricting femtocell access in wireless communication networks based on device capabilities. In accordance with some embodiments, a method includes receiving a registration request from a user device attempting to access a femtocell base station and retrieving device capability information from the user device. The device capability information includes an indication of whether the user device supports Voice over New Radio (VoNR). The method further includes determining that the device does not support VoNR and requires a fallback mechanism for voice communication. The method further includes determining that the femtocell base station is associated with a tracking area that does not support the fallback mechanism and sending a registration rejection message to the user device. The registration rejection message instructs the user device to prevent itself from accessing the femtocell base station for voice communication for a defined duration.

### TECHNICAL FIELD

Various embodiments of the present technology relate to wireless communication networks and, more particularly, systems and methods for restricting femtocell access based on device Voice over New Radio (VoNR) capability and tracking area identification.

### BACKGROUND

Wireless communication networks use a combination of macro cells and small cells to provide connectivity across different environments. Macrocells offer wide-area coverage, while small cells, such as femtocells, enhance service in localized areas where macro coverage is insufficient. Femtocells are low-power cellular base stations that connect to a core network via an internet connection, extending coverage indoors or in areas with weak macro signals. As Fifth Generation (5G) networks expand, small-cell deployments, including femtocells, may be used for maintaining service quality and network efficiency in areas with limited macro coverage. Similar small-cell architectures may also play a role in future wireless networks, such as 6G networks, to create seamless connectivity as new technologies and standards emerge.

In advanced wireless networks, voice and data services depend on the network’s ability to support real-time communication protocols. In 5G, for example, voice calls can be handled through Evolved Packet System Fallback (EPSFB), which transitions a call to Long Term Evolution (LTE), or through Voice over New Radio (VoNR), which keeps the call within 5G. Future networks will introduce new voice and data handling protocols, but the challenge of maintaining devices with different capabilities will persist. Networks must dynamically determine a device’s capability to ensure proper service continuity and prevent connectivity issues.

Tracking area identification (TAI) is an important aspect of mobility management in cellular networks, allowing operators to distinguish between different coverage zones. Each base station, including macro cells and femtocells, is assigned a TAI to manage registration, handovers, and network access. In deployments that mix legacy and next-generation technologies, TAIs may enable networks to control device access based on capability and service availability. As wireless technology advances, effective TAI management may remain essential for optimizing network operations and providing seamless user experiences.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to managing device access in a Fifth Generation (5G) standalone (SA) femtocell network based on Voice over New Radio (VoNR) capabilities. More specifically, the technology disclosed herein includes systems and methods for dynamically restricting access to femtocells for devices that only support Evolved Packet System Fallback (EPSFB) when the femtocell is deployed in areas with LTE coverage. In a first embodiment, a method includes receiving, via a wireless communication network, a registration request from a user device attempting to access a femtocell base station. The method further includes retrieving, from the user device, device capability information for the user device. The device capability information includes an indication of whether the user device has VoNR capability. The method further includes determining, based on the indication, that the user device does not have the VoNR capability and requires a fallback mechanism for voice communication and determining that the femtocell base station is associated with a tracking area that does not support the fallback mechanism. The method further includes sending, via the wireless communication network, a registration rejection message to the user device. The registration rejection message instructs the user device to prevent itself from accessing the femtocell base station for voice communication for a defined duration.

In some examples, the fallback mechanism includes EPSFB, which enables the user device to transition from a 5G network to a Fourth Generation (4G) Long Term Evolution (LTE) network to establish a voice call. In some examples, retrieving the device capability information for the user device includes requesting, from the user device, the device capability information in response to the registration request. The method may further include, after sending the registration rejection message, instructing the user device to attempt to access an alternative network that supports the fallback mechanism. The alternative network may include at least one of a macrocell network that provides wide-area coverage, a microcell network that provides localized coverage in the same geographic area as the femtocell base station, and a roaming network associated with a different network operator. In some examples, determining that the femtocell base station is associated with the tracking area that does not support the fallback mechanism includes identifying a tracking area identifier associated with the femtocell base station and determining, based on a comparison of the tracking area identifier to a list of tracking area identifiers of tracking areas with fallback mechanisms, that the tracking area lacks support for the fallback mechanism. The registration rejection message, in some examples, includes an Evolved Mobility Management (EMM) cause code. The method may further include receiving, via the wireless communication network, a second registration request from a second user device attempting to access the femtocell base station, determining that the second user device has the VoNR capability, and allowing the second user device to access the femtocell base station for a voice call.

In a second embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least receive, via a wireless communication network, a registration request from a user device attempting to access a femtocell base station. The program instructions further direct the processing system to retrieve, from the user device, device capability information for the user device, wherein the device capability information includes an indication of whether the user device has VoNR capability. The program instructions further direct the processing system to determine, based on the indication, that the user device does not have the VoNR capability and requires a fallback mechanism for voice communication and determine that the femtocell base station is associated with a tracking area that does not support the fallback mechanism. The program instructions further direct the processing system to send, via the wireless communication network, a registration rejection message to the user device. The registration rejection message instructs the user device to prevent itself from accessing the femtocell base station for voice communication for a defined duration.

In yet another embodiment, one or more non-transitory computer-readable storage media have program instructions stored thereon that, when executed by a computing system, direct the computing system to perform operations. The operations include receiving, via a wireless communication network, a registration request from a user device attempting to access a femtocell base station and retrieving, from the user device, device capability information for the user device. The device capability information includes an indication of whether the user device has VoNR capability. The operations further include determining, based on the indication, that the user device does not have the VoNR capability and requires a fallback mechanism for voice communication and determining that the femtocell base station is associated with a tracking area that does not support the fallback mechanism. The operations further include sending, via the wireless communication network, a registration rejection message to the user device. The registration rejection message instructs the user device to prevent itself from accessing the femtocell base station for voice communication for a defined duration.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless voice communications environment in accordance with some embodiments of the present technology;

FIG. 2 is a flowchart illustrating a series of steps performed by a wireless communications network in accordance with some embodiments of the present technology;

FIG. 3 is a sequence diagram illustrating a series of steps performed in a wireless communications environment in accordance with some embodiments of the present technology;

FIG. 4 illustrates an example of a wireless communications network in accordance with some embodiments of the present technology;

FIG. 5 illustrates an example of user equipment in accordance with some embodiments of the present technology;

FIG. 6 illustrates an example of a femtocell base station in accordance with some embodiments of the present technology; and

FIG. 7 illustrates a computing system suitable for implementing the various operational environments, architectures, processes, scenarios, and sequences discussed below and with respect to the other Figures.

### DETAILED DESCRIPTION

The present disclosure relates to systems and methods for managing device access in a Fifth Generation (5G) standalone (SA) femtocell network based on a device’s capability to support Voice over New Radio (VoNR). More specifically, the technology disclosed herein introduces a mechanism for dynamically restricting devices that rely on Evolved Packet System fallback (EPSFB) from registering on 5G femtocells deployed in areas where Long Term Evolution (LTE) coverage is unavailable. This restriction prevents devices without native VoNR support from experiencing service disruptions or degraded call quality when operating with the femtocell coverage area.

In 5G SA deployments, voice services can be handled through VoNR, which allows devices to remain on the 5G network during voice calls. However, many existing 5G devices were initially designed to use EPSFB, wherein voice calls revert to LTE when VoNR is unavailable. In macrocell environments, this fallback mechanism is functional as LTE coverage typically coexists with 5G. However, the introduction of 5G femtocells—small cellular base stations designed to enhance coverage in indoor or localized environments—presents a challenge when deployed in areas without LTE coverage. If a device relying on EPSFB attempts to make a voice call in a 5G-only femtocell, it will attempt to transition to LTE, which may not exist in that area. As a result, the device may lose service entirely, leading to failed calls and poor user experience.

To address this problem, the disclosed technology leverages the access and mobility management function (AMF) within the 5G core to evaluate a device’s capabilities during the registration process. The AMF is responsible for managing device access, mobility, and authentication. When a device attempts to register on a 5G femtocell, the AMF retrieves the device’s capability information, specifically checking whether it supports VoNR. If the device does not support VoNR and relies on EPSFB, the AMF evaluates the tracking area identifier (TAI) associated with the femtocell. If the femtocell operates in a region without LTE coverage, the AMF rejects the registration request for that device. The rejection message includes a specific Evolved Mobility Management (EMM) cause code that instructs the device to blacklist the femtocell’s TAI and refrain from attempting to reconnect for a defined period.

Implementations described herein use multiple signaling exchanges between the user equipment (UE), the femtocell base station (gNB), and the AMF. When a device powers on or moves into the femtocell coverage area, it initiates an initial registration request with the AMF. During this process, the AMF authenticates the device and establishes security procedures. Once security is established, the AMF sends an initial context setup request to the femtocell base station, which includes a request for the device’s capabilities. The UE responds with a UE radio capability info indication message that includes details on supported radio technologies, including whether it can natively support VoNR.

Upon receiving the capability information, the AMF cross-references the TAI of the registering femtocell base station. The AMF maintains a configurable database of TAIs corresponding to 5G femtocells, distinguishing those deployed in LTE-supported regions from those in LTE-limited areas. If the device lacks VoNR capability and the femtocell is identified as being in an LTE-limited region, the AMF rejects the registration request using a preconfigured EMM cause code 15 or another designated value. According to Third Generation Partnership Project (3GPP) standards, this cause code instructs the device to blacklist the femtocell’s TAI for an identified duration (e.g., 12 to 24 hours), preventing repeated registration attempts that could degrade network performance.

Various technical effects may be appreciated from the implementations disclosed herein. Such technical effects include a reduced number of failed connection attempts, improved call success rates, and optimized network performance by preventing unnecessary registration retries. For example, by dynamically evaluating device capabilities during the registration process, the AMF eliminates redundant signaling exchanges that would otherwise occur when EPS fallback-only device repeatedly attempt to connect to 5G femtocells in LTE-limited areas. This reduces processing overhead at the AMF and the base station by avoiding unnecessary authentication, security setup, and context establishment procedures for devices that cannot be supported. Additionally, the use of a configurable TAI database allows for efficient resource allocation, as the system can differentiate between femtocells deployed in LTE-covered and LTE-limited regions without modifying core network behavior. Furthermore, applying an EMM cause code to instruct a device to blacklist the femtocell TAI reduces excessive registration requests, thereby decreasing signaling congestion and improving spectral efficiency across the network.

While the technology described herein is primarily discussed in the context of 5G VoNR and 4G EPSFB/LTE for voice calling, the underlying principles and methodologies can be broadly applied to other generations of wireless communication technologies and protocols facing similar challenges. The disclosed solution, which dynamically evaluates device capabilities and selectively restricts network access based on service compatibility, can extend to future wireless standards, including 6G and beyond, where different fallback mechanisms or service transitions may be required. Similarly, in multi-RAT (Radio Access Technology) environments, where devices may attempt to access incompatible network layers due to evolving infrastructure support, a comparable capability-checking and selective access mechanism may be employed.

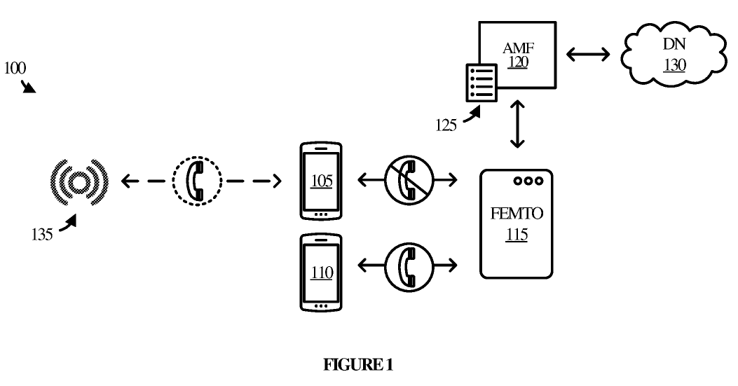

FIG. 1 illustrates wireless communications environment 100. Wireless communications environment 100 includes user equipment (UE) 105, UE 110, femtocell base station 115, AMF 120, TAI list 125, data network 130, and alternative network 135. The elements depicted in FIG. 1 are presented solely for purposes of example, and wireless communications environment 100 may include additional, fewer, or alternative elements than those illustrated in the example of FIG. 1.

In accordance with the present example, UE 105 is representative of a wireless user device that does not support VoNR. UE 110 is representative of a wireless user device that does support VoNR. Exemplary user devices include phones, smartphones, tablets, laptops, and other wireless communication devices capable of voice calling in a wireless network. UE 105 and UE 110 may each include components including but not limited to radio transceiver circuitry (XCVR), antennas, digital signal processing (DSP) components, amplifiers, filters, memory, as well as a central processing unit (CPU) and associated user circuitry for device operation. UE 105 and UE 110 wirelessly communicate with data network 120 via femtocell base station 115 and the 5G core network (e.g., core network 405) that includes AMF 120.

Femtocell base station 115 represents a network infrastructure element that facilitates wireless communication between user devices UE 105 and UE 110 and the broader network. Femtocell base station 115 may include components including but not limited to radio transceiver circuitry, antennas, DSP components, amplifiers, filters, memory, and processing circuitry to facilitate wireless communication with UE 105 and UE 110. Femtocell base station may further include software-defined networking (SDN) componentry, protocol stacks for 5G New Radio (NR), and network interfaces to enable connectivity with the core network and data network 130. Additionally, femtocell base station 115 may include radio resource management (RRM) modules, security mechanisms for authentication and encryption, and configurable TAIs for network access control and mobility management.

Femtocell base station 115 operates as a localized radio access point, enabling connectivity for devices within its coverage area. UE 110, which supports VoNR, can establish a direct 5G connection through femtocell base station 115, allowing both voice and data services without requiring fallback to LTE. Conversely, UE 105, which lacks VoNR capability, relies on EPSFB for voice communication. Because femtocell base station 115 is deployed in a tracking area without LTE coverage, EPSFB is not viable within the femtocell’s coverage. If no alternative LTE network (e.g., a roaming partner or microcell) is available, UE 105 would be unable to complete voice calls.

AMF 120 is a core network entity responsible for managing device registration, mobility, authentication, and access control within wireless communications environment 110. AMF 120 may be implemented as software running on virtualized or physical network infrastructure, such as within a cloud-native environment or a core network data center. AMF 120 interacts with other 5G core functions, such as the user data management (UDM), session management function (SMF), and policy control function (PCF), to facilitate network access and mobility management.

During the registration process, AMF 120 retrieves device capability information to determine whether the accessing UE supports VoNR and evaluates TAI list 125 to ascertain whether the registering femtocell base station is in an area lacking LTE coverage. TAI list 125, in some embodiments, is a list of TAIs of tracking areas that lack the fallback mechanism. TAI list 125 is a configurable data structure that may be stored in a database of AMF 120 or an external policy management system accessible via network interfaces. TAI list 125 includes a predefined mapping of TAIs corresponding to femtocell deployments and enables AMF 120 to dynamically reject registration attempts from devices that lack VoNR support. AMF 120 compares the TAI to TAI list 125 to determine whether the tracking area lacks support for the fallback mechanism. If a UE (e.g., UE 105) is identified as incompatible with VoNR and is attempting to connect via a femtocell within a restricted TAI, AMF 120 transmits a registration rejection message with an EMM cause code instructing the UE to blacklist the femtocell’s TAI and refrain from retrying registration for a predefined period of time.

After UE 105 blacklists femtocell base station 115, it may attempt to connect to alternative network 135, if available, to restore voice and data services. Alternative network 135 may represent a macrocell network, a microcell network, a roaming partner network, a Wi-Fi-based voice service (e.g., VoWiFi), or the like, that provides either LTE connectivity for EPSFB or an alternative voice communication method. Additionally, alternative network 135 may encompass different types of networks, including terrestrial, non-terrestrial, and space-based technologies. These may include communications involving low Earth orbit (LEO), medium Earth orbit (MEO), and/or geostationary orbit (GEO) satellites providing extended coverage in areas where traditional cellular infrastructure is unavailable or unreliable.

Upon detecting that femtocell base station 115 is unavailable for registration, UE 105 may scan for neighboring networks and attempt to reattach to a compatible LTE macrocell or roaming network by sending a tracking area update request (TAU) or registration request to an available eNodeB (for LTE) or gNB (for 5G NSA/SA). If no cellular fallback options are available, UE 105 may use Wi-Fi calling, if supported, by establishing a secure IP-based tunnel to the operator’s IMS (IP Multimedia Subsystem) core, enabling voice communication through alternative network 135 instead of the cellular network. If none of these alternative options are available—meaning UE 105 cannot connect to an LTE macrocell, a roaming partner network, a Wi-Fi calling service, a non-terrestrial network, a space-based communication system, or the like—then it will be unable to place or receive voice calls until it moves into an area with a compatible network that supports EPSFB or an alternative voice service.

If the registering device (e.g., UE 110) supports VoNR, AMF 120 processes the registration request without restriction. Upon receiving an indication of the device’s radio capability, AMF 120 verifies that the device supports VoNR and allows the registration to proceed. The AMF establishes the necessary signaling with femtocell base station 115, completing authentication, security setup, and initial context establishment procedures that may be required for network access. Because UE 110 does not require LTE fallback for voice services, it remains registered on femtocell base station 115.

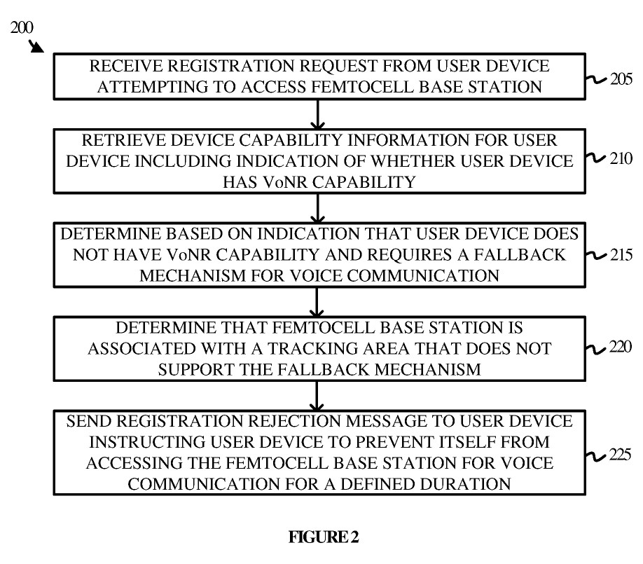

FIG. 2 illustrates process 200. Process 200 is an exemplary operation of femtocell restriction in wireless communications environment 100. The operations may vary in other examples. The operations of process 200, in some examples, are performed by an AMF, such as AMF 120 in the example of FIG. 1.

The operations of process 200 include receiving a registration request from a user device attempting to access a femtocell base station (step 205). In the example of FIG. 1, AMF 120 receives a registration request from UE 105 to access femtocell base station 115. UE 105 transmits the registration request wirelessly to femtocell base station 115 using RRC signaling over the NR interface. Femtocell base station 115 forwards the registration request to the 5G core network, where it is received by AMF 120 for processing. The registration request may include device-specific information, such as the Subscription Permanent Identifier (SUPI) or a 5G Globally Unique Temporary Identifier (5G-GUTI), which uniquely identifies UE 105 within the network. Additionally, the registration request may include a TAI associated with femtocell base station 115, allowing AMF 120 to determine the geographical or network area in which the registration attempt is occurring.

The operations of process 200 further include retrieving device capability information for the user device including an indication of whether the user device has VoNR capability (step 210). In the example of FIG. 1, AMF 120 retrieves device capability information for UE 105 including an indication of whether UE 105 has VoNR capability. The retrieval occurs as part of an initial context setup procedure, during which AMF 120 requests UE 105’s radio capability information to assess its support for 5G native voice services. The capability information is communicated from UE 105 to AMF 120 via femtocell base station 115 using a UE Radio Capability Info Indication message according to the relevant standards (e.g., 3GPP TS 38.413). The message may include various attributes related to the device’s network compatibility, including VoNR support, fallback requirements, and supported frequency bands. AMF 120 processes this information to determine whether UE 105 can sustain voice communication over 5G without relying on EPS fallback to LTE.

The operations of process 200 further include determining, based on the indication, that the user device does not have VoNR capability and requires a fallback mechanism for voice communication (step 215). In the example of FIG. 1, AMF 120 determines, based on the radio capability information, that UE 105 does not have VoNR capability and requires a fallback mechanism for voice communication. The determination that UE 105 does not support VoNR is made by AMF 120 after analyzing the UE Radio Capability Info Indication message received from UE 105 via femtocell base station 115. The radio capability information includes a parameter indicating whether the device supports VoNR or relies on EPS fallback to LTE for voice calls. Because UE 105 lacks VoNR support, it cannot complete voice calls over 5G SA and requires LTE for voice services. AMF 120 evaluates this requirement in conjunction with the TAI of femtocell base station 115, which indicates whether LTE coverage is available in the registration area. This assessment enables AMF 120 to determine whether UE 105 can successfully utilize EPS fallback in its current location.

The operations of process 200 further include determining that the femtocell base station is associated with a tracking area that does not support the fallback mechanism (step 220). In the example of FIG. 1, AMF 120 determines that femtocell base station 115 is associated with a tracking area that does not support EPSFB. The determination is based on TAI list 125, which contains predefined TAIs corresponding to femtocells deployed in locations where LTE coverage is unavailable. Upon receiving the registration request from UE 105, AMF 120 references TAI list 125, which may be stored within AMF 120's memory or an associated network database, to verify whether femtocell base station 115 is in an area where EPS fallback can be utilized. Because TAI list 125 indicates that femtocell base station 115 is in a location that lacks LTE coverage, EPSFB is not available for UE 105 in wireless communications environment 100. This determination informs subsequent actions taken by AMF 120 regarding whether to allow or reject the registration request from UE 105.

The operations of process 200 further include sending a registration rejection message to the user device instructing the user device to prevent itself from accessing the femtocell base station for voice communication for a defined duration (step 225). In the example of FIG. 1, AMF 120 sends a registration rejection message to UE 105 instructing it to prevent itself from accessing femtocell base station 115 for voice communication for a defined duration. The rejection message includes a specific EMM cause code (e.g., cause code 15, defined by 3GPP TS 24.501) to indicate that UE 105 should not attempt to re-register with the same tracking area for a period of time. In some examples, the period of time is between 12 and 24 hours. Upon receiving the message, UE 105 updates its internal forbidden tracking area list and applies the blackout period before attempting to reconnect to femtocell base station 115 for voice services. This process prevents unnecessary registration attempts from UE 105, reducing signaling congestion and ensuring that UE 105 does not experience repeated failed connection attempts due to the lack of EPS fallback support in the femtocell’s tracking area.

It should be noted that, in the example of FIG. 1, the registration rejection message applies specifically to voice communication. Thus, UE 105 can still utilize femtocell base station 115 for data services and other non-voice communication. As a result, UE 105 may continue to access data network 130 via femtocell base station 115, allowing functions such as internet browsing, messaging, and application data exchange to remain operational while voice calls are restricted.

Voice communication refers to the transmission of audible speech signals over a network, enabling real-time conversational exchanges between users via technologies such as circuit-switched calling, Voice over LTE (VoLTE), VoNR, and Voice over Wi-Fi (VoWiFi). Non-voice communication refers to forms of digital exchange that do not involve the transmission of real-time voice signals. Examples of non-voice communication include but are not limited to text messaging (SMS, MMS, RCS), internet browsing, email transmission, video streaming, file downloads/uploads, application data synchronization, instant messaging, push notifications, and machine-to-machine communication. Audible speech signals can also be shared as part of non-voice communication when they are not exchanged in real-time. For example, audio recordings, voice memos, and audio-based text messages (such as voice notes in messaging applications) may involve the transmission of digitized speech data as a file or media attachment rather than through a continuous, real-time voice channel. In these cases, the speech data is handled similarly to other forms of non-voice communication, such as file transfers or media streaming, and would not be restricted for UE 105 in the example of FIG. 1.

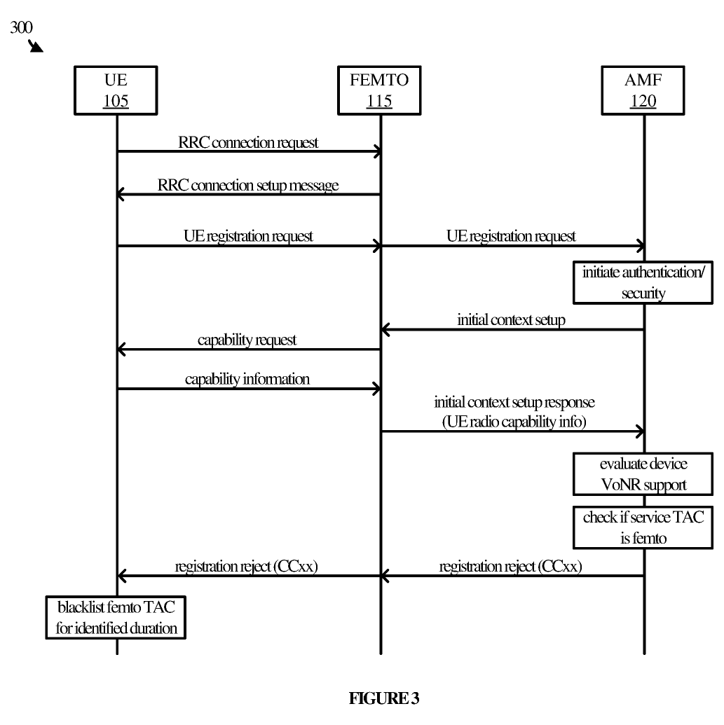

FIG. 3 illustrates sequence diagram 300. Sequence diagram 300 depicts an example sequence for femtocell restriction in a wireless communications environment. Sequence diagram 300 provides a representative flow of signaling interactions between UE 105, femtocell base station 115, and AMF 120 as part of the registration and capability evaluation process. The specific elements, operational steps, and message exchanges shown in FIG. 3 are exemplary and may vary in different implementations. Alternative embodiments may include additional, fewer, or modified operations while maintaining the core principles of femtocell restriction based on device capabilities and network conditions.

The sequence begins when UE 105 transmits an RRC connection request to femtocell base station 115 to establish an initial access link. Femtocell base station 115 responds with an RRC connection setup message, enabling the establishment of a radio link between UE 105 and femtocell base station 115 for further signaling exchanges. Once the radio connection is established, UE 105 sends a UE registration request to femtocell base station 115, which forwards the registration request to AMF 120. This registration request may include device-specific identifiers, such as 5G-GUTI (Globally Unique Temporary Identifier) or SUPI (Subscription Permanent Identifier), and a tracking area identifier that corresponds to the location of femtocell base station 115.

Upon receiving the registration request, AMF 120 initiates authentication and security procedures to verify the identity of UE 105 and establish encrypted communication. Authentication may involve interactions with the Authentication Server Function (AUSF) and User Data Management (UDM) components of the 5G core network (not shown in FIG. 3). Once authentication is complete, AMF 120 proceeds with the initial context setup process, which includes transmitting a capability request to UE 105 via femtocell base station 115. This request instructs UE 105 to provide its radio capability information, which includes an indication of whether the device supports VoNR or requires EPS fallback to LTE for voice communication.

UE 105 responds by sending a capability information message to AMF 120. The capability information message includes detailed UE radio capability parameters (e.g., as defined in 3GPP TS 38.413). The message informs AMF 120 whether UE 105 can complete voice calls over the 5G SA network or if it requires fallback to LTE for voice services. Upon receiving the capability information, AMF 120 performs an initial context setup response, incorporating the retrieved UE radio capability information into its session management process.

AMF 120 evaluates whether UE 105 supports VoNR by parsing the radio capability information received in the UE Radio Capability Info Indication message. AMF 120 also checks whether the Tracking Area Code (TAC) associated with femtocell base station 115 corresponds to a femtocell tracking area as defined in TAI list 125. If the tracking area is designated as femtocell-restricted and UE 105 does not support VoNR, then EPS fallback is not available for UE 105 in that location.

Based on these determinations, AMF 120 transmits a registration reject message to UE 105, including a specific EMM cause code (e.g., CCxx, such as cause code 15). The rejection instructs UE 105 to blacklist the TAI associated with femtocell base station 115 and prevent itself from retrying registration for a defined duration (e.g., 12 to 24 hours). The rejection prevents repeated failed registration attempts from UE 105, reducing signaling congestion and improving network efficiency.

Upon receiving the registration reject message, UE 105 updates its forbidden tracking area list so that it does not attempt to reconnect to femtocell base station 115 for voice services during the blacklist period. The restriction applies specifically to voice communication, meaning UE 105 may still access femtocell base station 115 for non-voice communication, such as data services, messaging, and application-based internet access.

While sequence diagram 300 presents a standard implementation of femtocell restriction based on device capability and tracking area constraints, alternative embodiments may introduce additional steps. For example, AMF 120 may interact with a Policy Control Function (PCF) to dynamically adjust the blacklist duration based on network load conditions. Similarly, UE 105 may perform an alternative network scan upon receiving the registration reject message and attempt to connect to alternative network 135. Such variations and enhancements may be implemented without deviating from the core principles described in FIG. 3.

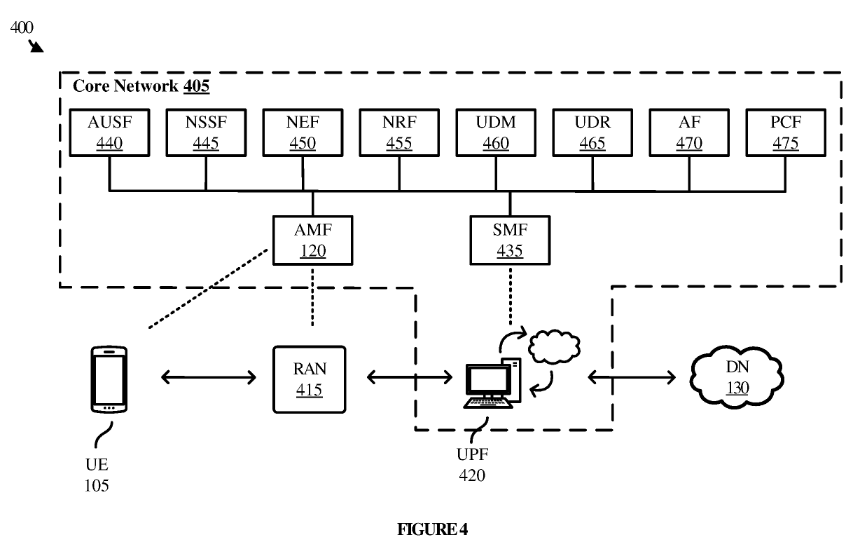

FIG. 4 illustrates 5G communication network 400. 5G communication network 400 is representative of a 5G communication network as disclosed herein in which femtocell access restriction processes may be implemented. 5G communication network 400 may be representative of wireless communications environment 100 in FIG. 1 in some examples. 5G communication network 400 includes core network 405, UE 105, radio access network (RAN) 415, user plane function (UPF) 420, and data network 130. Core network 405 includes AMF 120, Session Management Function (SMF) 435, Authentication Server Function (AUSF) 440, Network Slice Selection Function (NSSF) 445, Network Exposure Function (NEF) 450, Network Repository Function (NRF) 455, Unified Data Management (UDM) 460, Unified Data Repository (UDR) 465, Application Function (AF) 470, and Policy Control Function (PCF) 475. In other examples, 5G communication network 400 may include different or additional elements than those illustrated in FIG. 4 including but not limited to a session communication proxy (SCP), a migration function, a provisioning orchestrator, a customer relationship management (CRM) client, and the like.

RAN 415 represents a radio access network that facilitates communication between UE 105 and core network 450. RAN 415 includes femtocell base station 115 from FIG. 1 in some examples. RAN 415 may be implemented as a terrestrial network, non-terrestrial network, or hybrid network in which multiple access technologies are integrated to provide greater connectivity. RAN 415 implemented at least in part as various types of terrestrial networks, including macrocell, microcell, and femtocell architectures, supporting LTE, 5G NSA/SA, and other cellular technologies. Additionally, RAN 415 may include non-terrestrial network (NTN) technologies, including airborne platforms such as high-altitude platform stations (HAPS) and unmanned aerial vehicles (UAVs), as well as space-based communication systems such as low Earth orbit (LEO), medium Earth orbit (MEO), or geostationary orbit (GEO) satellites. In hybrid configurations, RAN 415 may combine terrestrial and non-terrestrial elements to optimize coverage, capacity, and resilience in a multitude of deployment scenarios.

AMF 120 is responsible for access and mobility management including the initial registration of devices, authentication, tracking area management, and ensuring that users remain connected as they move through the network. AMF 120 serves as the point of contact for user devices (e.g., UE 105) when they try to connect to the 5G network (e.g., 5G communication network 400). AMF 120 manages the establishment, maintenance, and termination of the connection between UE 105 and core network 405. SMF 435 is responsible for session management including establishing, modifying, and releasing sessions (which comprise of one or more data flows). SMF 435 also selects and manages the user plane functions, handles aspects of internet protocol (IP) address allocation, and maintains the rules for how data should be routed and reported. SMF 435 ensures that data can be successfully transmitted between UE 105 and the internet or other network services.

AUSF 440 is also responsible for aspects of user authentication. AUSF, in part, generates and validates authentication vectors to ensure that the requesting device is a legitimate subscriber of 5G communication network 400. Upon successful authentication, AUSF 440 contributes to establishing a secure communication channel between UE 105 and core network 405 by facilitating the generation and distribution of security keys. AUSF 440 may also support network slicing by authenticating access to different network slices based on user subscription. AUSF 440 also supports roaming by interacting with corresponding authentication functions in other networks.

NSSF 445 is responsible for selecting the appropriate network slice for UE 105 based on UE 105’s subscription data and requested service. This may involve determining which slice or slices are best suited to meet the specific service requirements and the subscription profile associated with UE 105. NSSF 445 is also responsible for enforcing policies related to network slice access, managing information about the network slices, and interacting with other core network functions to ensure that UE 105 is connected to the correct slice and that slice-specific rules are applied.

NEF 450 plays a role in securely exposing the capabilities of core network 405 to external applications and services. NEF 450 may perform functions such as providing standardized application programming interfaces (APIs) for third-party services to access specific network capabilities or information and ensuring that the exposure of network capabilities and user data is managed securely and user privacy is maintained. NRF 455 acts as a central registry and discovery service for the network functions within core network 405. NRF 455 allows other network functions to register their services and discover the services provided by other network functions, maintains up-to-date information on the services offered by different network functions, supports load balancing and fault tolerance mechanisms within the network, and supports the scalability of the network.

UDM 460 is a central entity for managing subscriber data and authentication information. UDM 460 stores and manages subscription-specific information and is responsible for handling the authentication and authorization of users trying to access the network. Although not directly managing sessions, UDM 460 provides necessary information to other network functions, such as AMF 120 and SMF 435, to assist in session establishment and management based on the subscriber’s data. UDM 460 also supports seamless service continuity and roaming by managing user identities and security information across different types of networks.

UDR 465 acts as a database (or multiple databases) for storing and managing structured subscriber data and service information. UDR 465 manages access to subscription data for other network functions such as AMF 120, SMF 435, and UDM 460. AF 470 is representative of external applications and services that may need to interact with core network 405 for various purposes. PCF 475 is responsible for policy management, which involves creating and enforcing policy rules for network behavior and user data transmission.

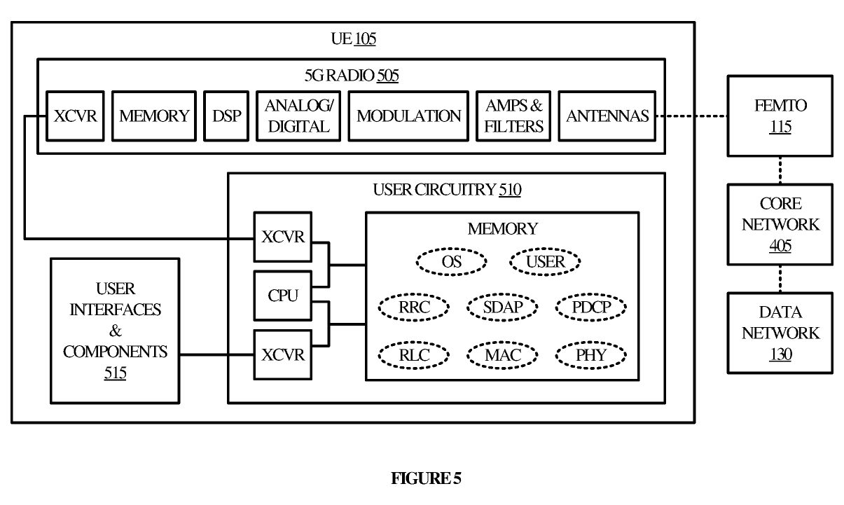

FIG. 5 illustrates an example of UE 105 from the preceding Figures in which UE 105 is configured for use in a 5G network (e.g., 5G communication network 405). In the example of FIG. 5, UE 105 is wirelessly coupled to femtocell base station 115, core network 405 via femtocell base station 115, and data network 130 via core network 405. In the example of FIG. 5, UE 105 includes 5G radio 505, user circuitry 510, and user interfaces and components 515. 5G radio 505 includes 5GNR antennas, amplifiers, filters, modulation, analog-to-digital interfaces, digital signal processors (DSPs), memory, and radio transceiver circuitry (XCVR) that are coupled over bus circuitry. User circuitry 510 includes memory, CPU, and XCVRs that are coupled over bus circuitry. UE 105 may differ from what is shown in the example of FIG. 5, particularly because UE 105 lacks support for VoNR and instead relies on EPSFB to LTE for voice communication.

The memory in user circuitry 510 stores an operating system (OS), user applications (USER), and 5GNR network applications for the physical layer (PHY), MAC layer, radio link control (RLC), packet data convergence protocol (PDCP), service data adaptation protocol (SDAP), and radio resource control (RRC). The antennas in 5G radio 505 are wirelessly coupled to femtocell base station 115 over a 5GNR link. Transceivers in 5G radio 505 are coupled to a transceiver in user circuitry 510. Another transceiver in user circuitry 510 is coupled to user interfaces and components 515, which may include displays, controllers, and/or memory. However, because UE 105 does not support VoNR, additional components or software elements that would normally handle 5G-native voice services may be absent or deactivated. For example, VoNR-specific protocol stack optimizations, IMS-based VoNR registration procedures, and QoS configurations dedicated to VoNR services may not be present. Instead, UE 105 may include fallback mechanisms for initiating and handling voice calls over LTE such as additional NAS signaling procedures, LTE-specific IMS registration capabilities, and LTE fallback timers implemented within user circuitry 510.

In 5G radio 505, the antennas receive wireless signals from femtocell base station 115 that transport downlink 5GNR signaling and data. The antennas transfer corresponding electrical signals through duplexers to the amplifiers. The amplifiers boost the received signals for filters, which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 510 over the transceivers. 5G radio 505 and user circuitry 510 may include fallback logic to determine whether LTE service is available before attempting to initiate a voice call. In scenarios where UE 105 registers to a 5G-only femtocell, such as femtocell base station 115, and no LTE network is available in the associated tracking area, the device will be unable to complete a voice call, resulting in a rejected registration attempt.

In user circuitry 510, the CPU executes the network applications to process the 5GNR symbols and recover the downlink 5GNR signaling and data. The 5GNR network applications receive new uplink signaling and data from the user applications. The network applications process the uplink user signaling and downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data. If UE 105 attempts to initiate a voice call, the RRC layer and NAS signaling mechanisms may attempt to transition the device to an LTE network for EPS fallback. If no LTE network is available, the voice call setup will fail.

In 5G radio 505, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters, which attenuate unwanted out-of-band energy. The filters transfer the filtered uplink signals through duplexers to the antennas. The electrical uplink signals drive the antennas to emit corresponding wireless 5GNR signals to femtocell base station 115, transporting the uplink 5GNR signaling and data. However, because UE 105 lacks VoNR capability, its 5G network applications will not generate VoNR-specific signaling and will instead rely on LTE transition signaling (e.g., EPSFB handover requests, LTE tracking area updates) when voice services are required.

RRC functions may include but are not limited to authentication, security, handover control, status reporting, QoS, network broadcasts and pages, and network selection. Because UE 105 does not support VoNR, RRC signaling associated with VoNR call setup procedures may be absent, replaced instead by RRC signaling for LTE when initiating a voice call. SDAP functions may include but are not limited to QoS marking and flow control, though VoNR-specific QoS flow configurations (e.g., QoS Flow Identifier (QFI) for voice services) may not be present in UE 105. PDCP functions may include but are not limited to security ciphering, header compression and decompression, sequence numbering and re-sequencing, and de-duplication, though certain VoNR-specific optimizations may be excluded.

MAC functions may include but are not limited to buffer status, power control, channel quality, HARQ, user identification, random access, user scheduling, and QoS. Because UE 105 lacks VoNR capability, certain VoNR-specific MAC-layer optimizations (such as low-latency HARQ configurations for voice packets) may be absent. PHY functions may include but are not limited to packet formation/deformation, windowing/de-windowing, guard-insertion/guard-deletion, control insertion/removal, interleaving/de-interleaving, forward error correction (FEC) encoding/decoding, channel coding/decoding, channel estimation/equalization, and rate matching/de-matching, scrambling/descrambling, modulation mapping/de-mapping, layer mapping/de-mapping, precoding, resource element (RE) mapping/de-mapping, fast Fourier transforms (FFTs)/inverse FFTs (IFFTs), and discrete Fourier transforms (DFTs)/inverse DFTs (IDFTs). However, PHY-layer VoNR optimizations such as beamforming enhancements for voice services may not be utilized in UE 105.

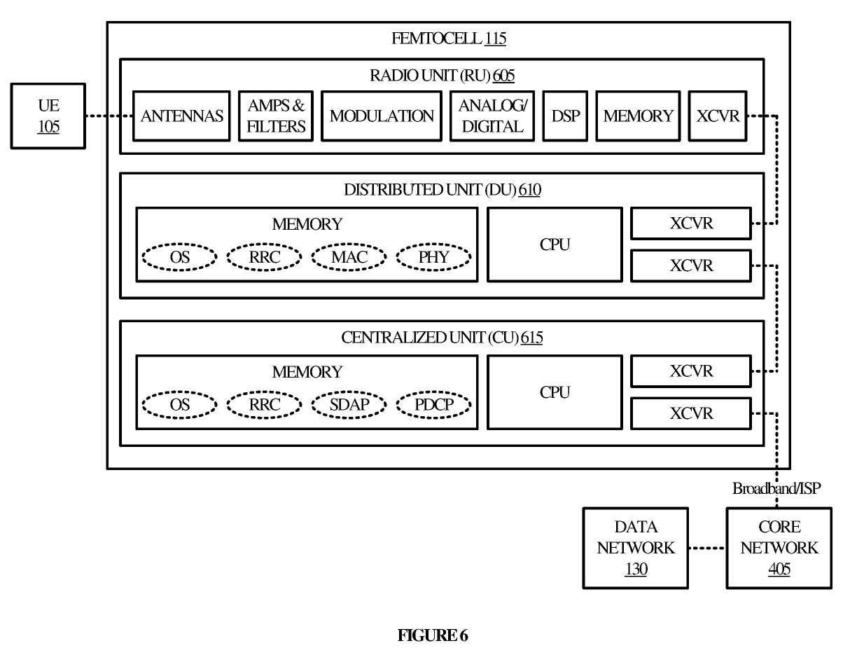

FIG. 6 illustrates an example of femtocell base station 115 from the preceding Figures, in which femtocell base station 115 is a gNB configured for use in a 5G network (e.g., 5G communication network 400). Unlike a macro gNB, femtocell base station 115 operates as a small-scale, low-power network node, typically deployed in indoor or small-area environments to provide localized 5G coverage. In the example of FIG. 6, femtocell base station 115 is wirelessly coupled to UE 105, core network 405, and data network 130 via core network 405. Unlike traditional macro gNBs, which connect to the core network via dedicated fiber or microwave backhaul, femtocell base station 115 may connect to core network 405 via a broadband/ISP connection in some examples, as shown in FIG. 6. Femtocell base station 115 may differ from what is shown in the example of FIG. 6, depending on specific deployment configurations and integration levels.

In the example of FIG. 6, femtocell base station 115 includes radio unit (RU) 605, distributed unit (DU) 610, and centralized unit (CU) 615. However, in some femtocell implementations, these components may be partially or fully integrated into a single physical unit to optimize cost, power consumption, and deployment complexity. RU 605 may include, but is not limited to, antennas, amplifiers, filters, modulation components, analog-to-digital interfaces, digital signal processors (DSPs), memory, and radio transceiver circuitry (XCVR), all of which facilitate wireless communication with UEs. UE 105 is wirelessly coupled to antennas in RU 605 over 5GNR links. Transceivers in RU 605 are coupled to transceivers in DU 610 over fronthaul links, such as enhanced Common Public Radio Interface (eCPRI). The DSPs in RU 605 execute radio applications to process 5GNR signals received from UE 105 and exchange processed 5GNR data with DU 610.

For uplink transmission, the antennas in RU 605 receive wireless signals from UE 105, which transport uplink 5GNR signaling and data. The antennas transfer corresponding electrical signals through duplexers to amplifiers. The amplifiers boost the received signals for filters, which attenuate unwanted noise and interference. Demodulators down-convert the amplified signals from their carrier frequencies. The analog-to-digital interfaces convert the demodulated analog signals into digital signals for DSP processing. The DSPs transfer the corresponding 5GNR symbols to DU 610 over the transceivers.

For downlink transmission, the DSPs receive downlink 5GNR symbols from DU 610. The DSPs process the downlink 5GNR symbols to generate corresponding digital signals for the analog-to-digital interfaces. The analog-to-digital interfaces convert the digital signals into analog signals for modulation. The modulation components up-convert the analog signals to their carrier frequencies. The amplifiers boost the modulated signals for the filters, which attenuate unwanted out-of-band energy. The filters transfer the filtered electrical signals through duplexers to the antennas. The filtered electrical signals drive the antennas to emit corresponding wireless signals to UE 105, transporting the downlink 5GNR signaling and data.

DU 610 may include, but is not limited to, memory, CPU, and transceivers (XCVRs), which are coupled over bus circuitry. The memory in DU 610 stores operating systems (OS) and 5GNR network applications, such as RRC, MAC, and PHY. CU 615 may include, but is not limited to, memory, CPU, and transceivers (XCVRs), which are coupled over bus circuitry. The memory in CU 615 stores an OS and 5GNR network applications, including PDCP, SDAP, and RRC. In femtocell implementations, DU 610 and CU 615 may be integrated into a single processing unit, rather than existing as separate entities, to reduce hardware complexity and cost. Transceivers in DU 610 may be coupled to transceivers in RU 605 over fronthaul links, while transceivers in DU 610 may be coupled to transceivers in CU 615 over midhaul links.

Because femtocell base station 115 is designed for localized coverage, certain macro gNB functionalities such as extensive mobility control, inter-gNB handovers, and multi-user scheduling optimizations may be limited or excluded. However, RRC functions in CU 615 may still include connection establishment and release, radio bearer configuration, paging coordination, and security configuration. The MAC layer may handle buffer status reporting, power control, user scheduling, and QoS enforcement, but with simplified scheduling algorithms optimized for small-scale deployments.

PHY, PDCP, and SDAP functions remain similar to those in macro gNBs, but optimizations may exist for low-power operation, reduced processing overhead, and backhaul efficiency due to femtocell base station 115 relying on a broadband/ISP connection instead of dedicated core network transport.

In connection with the preceding Figures and processes, RU 605 may facilitate the initial exchange of RRC signaling between UE 105 and femtocell base station 115, which includes the RRC connection request and setup messages required for registration. DU 610 processes MAC and PHY layer functions, which are responsible for managing uplink and downlink transmissions, including the transmission of UE capability information to AMF 120 via the core network. CU 615 executes higher-layer network functions, such as PDCP and SDAP processing, which handle protocol data encapsulation and QoS enforcement during registration. These elements collectively support the signaling flow described in the preceding Figures, including registration requests, initial context setup, capability retrieval, and registration rejection handling. Additionally, the broadband/ISP connection to core network 405 supports routing of NAS messages between UE 105, femtocell base station 115, and AMF 120 such that tracking area evaluation and registration control can occur as intended within the femtocell environment.

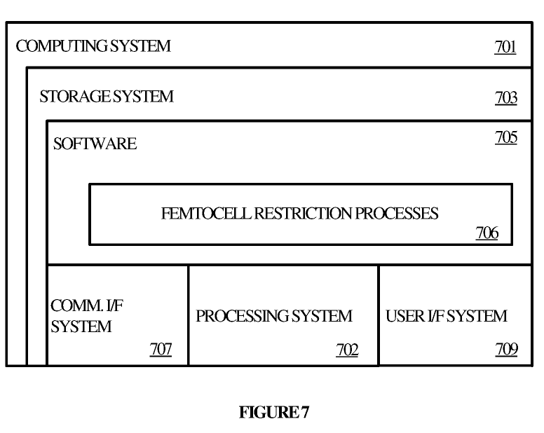

FIG. 7 illustrates computing system 701, which is representative of any system or collection of systems in which the various processes, programs, services, and scenarios disclosed herein may be implemented. Examples of computing system 701 include, but are not limited to, server computers, cloud computing platforms, and data center equipment configured to host network functions such as an AMF, SMF, or other 5G core components. Additionally, computing system 701 may represent physical or virtualized server machines, containerized environments, and distributed computing platforms deployed within a telecommunications network. In some implementations, computing system 701 may also encompass desktop computers, laptop computers, tablet devices, and wearable computing devices, depending on the application context.

Computing system 701 may be implemented as a single apparatus, system, or device or in a distributed manner across multiple computing instances, such as cloud-based infrastructure or virtualized network functions (VNFs) operating within a data center environment. Computing system 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements femtocell restriction processes 706, which is representative of the processes for restricting femtocell access and managing device registration based on VoNR capability, as discussed with respect to the preceding Figures, such as process 200. When executed by processing system 702, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including femtocell restriction processes 706) may be implemented in program instructions and among other functions may, when executed by processing system 702, direct processing system 702 to operate as described with respect to the various operational scenarios, sequences, and processes illustrated herein. For example, software 705 may include program instructions for sending or receiving location data between one or more devices as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to perform the processes described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Although the descriptions provided herein may be in the context of certain radio access technologies, networks, and network topologies, such as 4G LTE or 5G/NR mobile communications, the proposed concepts, schemes, and any variations thereof may be implemented in, for, and by other types of radio access technologies, networks, and network topologies. Such radio access technologies, networks, and network topologies may include, for example and without limitation, Internet-of-Things (IoT), Narrow Band Internet of Things (NB-IoT), vehicle-to-everything (V2X), fixed wireless internet, non-terrestrial networks (NTN), and space-based technologies, such as communications involving low Earth orbit (LEO), medium Earth orbit (MEO), or geostationary orbit (GEO) satellites. Thus, the scope of the disclosure is not limited to the examples described herein.

As will be appreciated by one skilled in the art, aspects of the present invention may be embodied as a system, method, computer program product, or otherwise. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms ‘connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
receiving, via a wireless communication network, a registration request from a user device attempting to access a femtocell base station;
retrieving, from the user device, device capability information for the user device, wherein the device capability information includes an indication of whether the user device has Voice over New Radio (VoNR) capability;
determining, based on the indication, that the user device does not have the VoNR capability and requires a fallback mechanism for voice communication;
determining that the femtocell base station is associated with a tracking area that does not support the fallback mechanism; and
sending, via the wireless communication network, a registration rejection message to the user device, wherein the registration rejection message instructs the user device to prevent itself from accessing the femtocell base station for voice communication for a defined duration.

2. The method of claim 1, wherein the fallback mechanism comprises Evolved Packet System Fallback (EPSFB), wherein the EPSFB enables the user device to transition from a Fifth Generation (5G) network to a Fourth Generation (4G) Long Term Evolution (LTE) network to establish a voice call.

3. The method of claim 1, wherein retrieving the device capability information for the user device comprises requesting, from the user device, the device capability information in response to the registration request.

4. The method of claim 1, further comprising, after sending the registration rejection message, instructing the user device to attempt to access an alternative network that supports the fallback mechanism, wherein the alternative network comprises at least one of:
a macrocell network that provides wide-area coverage;
a microcell network that provides localized coverage in the same geographic area as the femtocell base station; and
a roaming network associated with a different network operator.

5. The method of claim 1, wherein determining that the femtocell base station is associated with the tracking area that does not support the fallback mechanism comprises:
identifying a tracking area identifier associated with the femtocell base station; and
determining, based on a comparison of the tracking area identifier to a list of tracking area identifiers of tracking areas with fallback mechanisms, that the tracking area lacks support for the fallback mechanism.

6. The method of claim 1, wherein the registration rejection message includes an Evolved Mobility Management (EMM) cause code.

7. The method of claim 1, further comprising:
receiving, via the wireless communication network, a second registration request from a second user device attempting to access the femtocell base station;
determining that the second user device has the VoNR capability; and
allowing the second user device to access the femtocell base station for a voice call.

8. A system comprising:
one or more computer-readable storage media;
a processing system operatively coupled with the one or more computer-readable storage media; and
program instructions stored on the one or more computer-readable storage media, wherein the program instructions, when read and executed by the processing system, direct the processing system to at least:
receive, via a wireless communication network, a registration request from a user device attempting to access a femtocell base station;
retrieve, from the user device, device capability information for the user device, wherein the device capability information includes an indication of whether the user device has Voice over New Radio (VoNR) capability;
determine, based on the indication, that the user device does not have the VoNR capability and requires a fallback mechanism for voice communication;
determine that the femtocell base station is associated with a tracking area that does not support the fallback mechanism; and
send, via the wireless communication network, a registration rejection message to the user device, wherein the registration rejection message instructs the user device to prevent itself from accessing the femtocell base station for voice communication for a defined duration.

9. The system of claim 8, wherein the fallback mechanism comprises Evolved Packet System Fallback (EPSFB), wherein the EPSFB enables the user device to transition from a Fifth Generation (5G) network to a Fourth Generation (4G) Long Term Evolution (LTE) network to establish a voice call.

10. The system of claim 8, wherein to retrieve the device capability information for the user device, the program instructions direct the processing system to request, from the user device, the device capability information in response to the registration request.

11. The system of claim 8, wherein the program instructions further direct the processing system to, after sending the registration rejection message, instruct the user device to attempt to access an alternative network that supports the fallback mechanism, wherein the alternative network comprises at least one of:
a macrocell network that provides wide-area coverage;
a microcell network that provides localized coverage in the same geographic area as the femtocell base station; and
a roaming network associated with a different network operator.

12. The system of claim 8, wherein to determine that the femtocell base station is associated with the tracking area that does not support the fallback mechanism, the program instructions direct the processing system to:
identify a tracking area identifier associated with the femtocell base station; and
determine, based on a comparison of the tracking area identifier to a list of tracking area identifiers of tracking areas with fallback mechanisms, that the tracking area lacks support for the fallback mechanism.

13. The system of claim 8, wherein the registration rejection message includes an Evolved Mobility Management (EMM) cause code.

14. The system of claim 8, wherein the program instructions further direct the processing system to:
receiving, via the wireless communication network, a second registration request from a second user device attempting to access the femtocell base station;
determining that the second user device has the VoNR capability; and
allowing the second user device to access the femtocell base station for a voice call.

15. One or more non-transitory computer-readable storage media having program instructions stored thereon, wherein the program instructions, when executed by a computing system, direct the computing system to perform operations, the operations comprising:
receiving, via a wireless communication network, a registration request from a user device attempting to access a femtocell base station;
retrieving, from the user device, device capability information for the user device, wherein the device capability information includes an indication of whether the user device has Voice over New Radio (VoNR) capability;
determining, based on the indication, that the user device does not have the VoNR capability and requires a fallback mechanism for voice communication;
determining that the femtocell base station is associated with a tracking area that does not support the fallback mechanism; and
sending, via the wireless communication network, a registration rejection message to the user device, wherein the registration rejection message instructs the user device to prevent itself from accessing the femtocell base station for voice communication for a defined duration.

16. The one or more non-transitory computer-readable storage media of claim 15, wherein the fallback mechanism comprises Evolved Packet System Fallback (EPSFB), wherein the EPSFB enables the user device to transition from a Fifth Generation (5G) network to a Fourth Generation (4G) Long Term Evolution (LTE) network to establish a voice call.

17. The one or more non-transitory computer-readable storage media of claim 15, wherein retrieving the device capability information for the user device comprises requesting, from the user device, the device capability information in response to the registration request.

18. The one or more non-transitory computer-readable storage media of claim 15, the operations further comprising, after sending the registration rejection message, instructing the user device to attempt to access an alternative network that supports the fallback mechanism, wherein the alternative network comprises at least one of:
a macrocell network that provides wide-area coverage;
a microcell network that provides localized coverage in the same geographic area as the femtocell base station; and
a roaming network associated with a different network operator.

19. The one or more non-transitory computer-readable storage media of claim 15, wherein determining that the femtocell base station is associated with the tracking area that does not support the fallback mechanism comprises:
identifying a tracking area identifier associated with the femtocell base station; and
determining, based on a comparison of the tracking area identifier to a list of tracking area identifiers of tracking areas with fallback mechanisms, that the tracking area lacks support for the fallback mechanism.

20. The one or more non-transitory computer-readable storage media of claim 15, wherein the registration rejection message includes an Evolved Mobility Management (EMM) cause code.
